(19) United States
(12) Patent Application Publication
(10) Pub. No.: US 2003/0001006 A1
(43) Pub. Date: Jan. 2, 2003

(54) Apparatus and method for electronic payment with strengthened authentification capability and vending machine equiped with the same apparatus

(76) Inventor: Myung-Gi Lee, Kyunggi-Do (KR)

Correspondence Address: PENNIE & EDMONDS LLP, 1667 K STREET NW, SUITE 1000, WASHINGTON, DC, 20006

(21) Appl. No.: 09/985,869

(22) Filed: Nov. 6, 2001

(30) Foreign Application Priority Data
Jun. 27, 2001 (KR) 2001-37218

(51) Int. Cl. G06F 7/08

(52) U.S. Cl. 235/381

(57) ABSTRACT

The object of the invention is to provide an apparatus for electronic payment with strengthened authentication capability that is even capable of selectively selling restricted sales commodities. Another object of the present invention is to provide an apparatus for electronic payment that is capable of a high speed processing of personal authentication and transaction information.

### BACKGROUND OF THE INVENTION

The present invention is related to electronic payment systems. More particularly, the invention relates to a method and apparatus for electronic payment with strengthened authentication capability suitable for small sum payments of commodities whose sale are restricted such as adult goods.

The commodities that can be sold through the conventional web sites or vending machines are restricted. This is mainly due to the absence of technical solution for providing means for a secure and reliable personal authentication for the transaction of restricted sales goods such as adult goods.

Also, a local oriented membership based service of the conventional vending machines was not available. As far as the vending machines are concerned, the level of the service hovered around allowing a renewal of credit through membership cards. Naturally, the computing of total sales amount or remote management is almost impossible to realize.

In the mean time, the authentication technologies based on identification of particular parts of human bodies are beginning to be applied to electronic commerce. These technologies include a plurality of terminals connected to a server and the terminals further include image-capturing means that can scan or photograph the particular parts of a body. The scanned data are codified and transmitted to the server. Subsequently, the sever compares the codes with the uniquely stored data for each individual and returns the authentication result.

However, the introduction of these technologies have significantly lengthen the data transaction time resulting serious inconveniences for the users. Further, the distribution of uniquely personal information on the network has always been exposed to the possibility of outside hacking resulting serious consequences.

### SUMMARY OF THE INVENTION

The present invention is designed to overcome the above problems of prior art. The object of the invention is to provide an apparatus for electronic payment with strengthened authentication capability that is even capable of selectively selling restricted sales commodities.

Another object of the present invention is to provide an apparatus for electronic payment that is capable of a high speed processing of personal authentication and transaction information.

A further object of the present invention is to provide an apparatus for electronic payment that is capable of either minimizing frequency or eliminating the distribution of personal information on the network therefore minimizing the possibility of outside hacking.

Still another object of the present invention is to provide an apparatus for electronic payment that is capable of rapidly identifying the users with bad credit records.

### BRIEF DESCRIPTION OF THE DRAWINGS

FIG. 1 briefly illustrates an overall construction of a vending machine system according to the present invention.

FIG. 2 briefly illustrates one embodiment of electronic payment system according to the present invention applied to electronic commerce on the Web.

FIG. 3 shows a block diagram which illustrates the overall configuration of the electronic payment apparatus according to the present invention.

FIG. 4 shows a flow chart diagram which illustrates an overall process flow of the electronic cash system according to the present invention.

FIG. 5 shows a flow chart diagram which illustrates the communication process for a data renewal between the electronic payment process and the management server.

### DETAILED DESCRIPTION OF THE EMBODIMENTS

According to one embodiment of the present invention, the electronic payment apparatus is connected to a management server 30 through the network and is implemented by an electronic payment apparatus 80 either located at inside of a vending machine or on a personal computer and computes body identification codes by processing the data output obtained by scanning the particular parts of a body, processes for personal authentication by comparing between the codes ascertained as above and the codes read from a card type storage medium, and determines the suitability of the user for the restricted sale from personal information read from the card type storage medium.

More specifically, the electronic payment apparatus according to one embodiment of the present invention comprises: a card reader section 320 which reads personal information, the first body identification codes, and payment amount information from a card type storage medium; a scan section 310 which scans one particular part of a body and outputs the body identification data; a personal authentication section 121 which computes the second body identification codes from the body identification data of the scan section 310 and processes the personal authentication by comparing between the first body identification codes from the card reader section 320 and the second body identification codes; a authentication processing section 120 that includes a restricted authentication section which determines whether or not a user is eligible for a restricted transaction from the personal information obtained from the card reader section 320; a payment processing section 110 which receives the payment request from outside, executes payment process based on the payment amount information read from the card reader section 320 and the authentication result from the authentication processing section 120, stores the result in a payment database 210, and controls the card reader section to renew the payment amount data in the card type storage medium; and a display section 500 which displays the payment result information.

Also, the electronic payment apparatus according to one embodiment of the present invention further comprises a restricted authentication section which adds the body identification data such as finger print or iris identification in the personal authentication section in order to determines whether or not a user is eligible for a restricted transaction from the personal information stored in the card reader section subsequently allows an automatic sale of tobacco and adult goods which are only allowed to be sold to people above a certain age limit.

Furthermore, the scanned body identification data are not distributed on the network but personally authenticated through a comparison to the stored data on the card therefore minimizing the possibility of outside hacking.

The authentication processing section 120 of the electronic payment apparatus according to another embodiment of the present invention further comprises a credit inquiry section 123 which determines whether or not a user is eligible for a transaction by inquiring through the credit database with the user identification information.

Hence, the electronic payment apparatus according to the present invention has an advantage of being able to instantly recognize the users with bad credit records without the need to inquire into the network.

The electronic payment apparatus according to a further embodiment of the present invention further comprises a data renewal section 400 which periodic or non-periodically connects to a management server 30 in order to renew a credit database 220 and transmits the changes in the payment history of the payment database 210.

Accordingly, the electronic payment apparatus according to the present invention can not only maintain the credit database with the most up to date information but also can calculate the total sales amount or check the inventory from a remote location. As a result, the customer reliability will improve by always maintaining a fixed amount of inventory.

The electronic payment method according to one embodiment of the present invention comprises the steps of: reading personal information, the first body identification codes, and balance information from a card type storage medium; scanning one particular part of a user's body; calculating the second body identification codes by processing the scanned data; personally authenticating by comparing between the first body identification codes and the second body identification codes and determining whether or not the user is eligible for a restricted transaction from the personal information; executing the payment process based on the balance information by receiving the payment request information from outside when successful in authenticating, and storing the result in a payment database, and renewing the payment amount in a card type storage medium; and displaying the transaction result.

Hereinafter, preferred embodiments of the present invention will be described in detail with reference to the accompanying drawings.

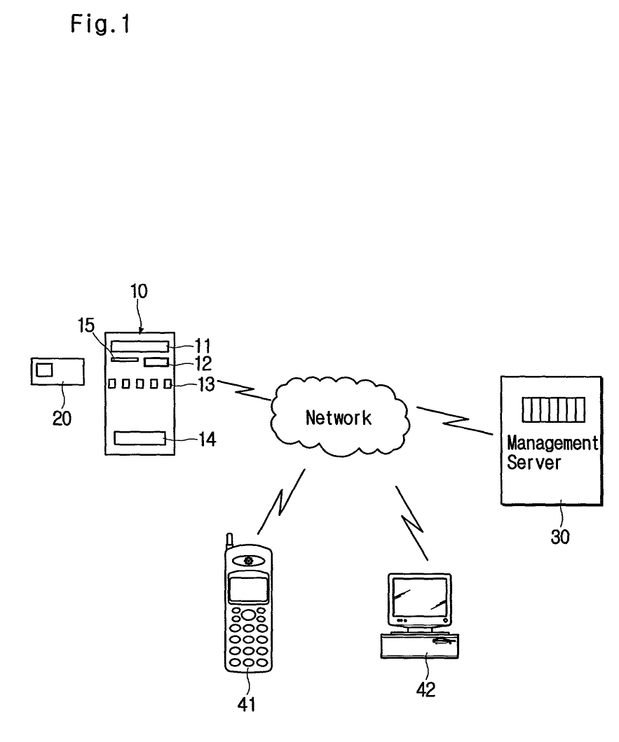

FIG. 1 briefly illustrates an overall construction of a vending machine system according to the present invention. As illustrated, the electronic payment system according to the present invention is provided as a part of a conventional vending machine 10. The vending machine comprises a display window 11, a display section 12 that indicates sales information, menu buttons 13, a goods outlet 14 and an interface section 15 that includes an IC card reader or a finger print recognition module depending on particular embodiment of the present invention.

An electronic payment apparatus is connected to a management server 30 through a cable or wireless network. The fact that a plurality of management server 30 can exist locally and they can also form a hierarchical structure connected by a network will become apparent to those skilled in the art. Also, the management server 30 is accessible through a terminal connected to the network. Hence, the manager can check the inventory or the sales amount of each of the vending machines from a remote location by connecting through the management server 30 via a personal computer 42, or mobile phone or personal digital assistance (PDA).

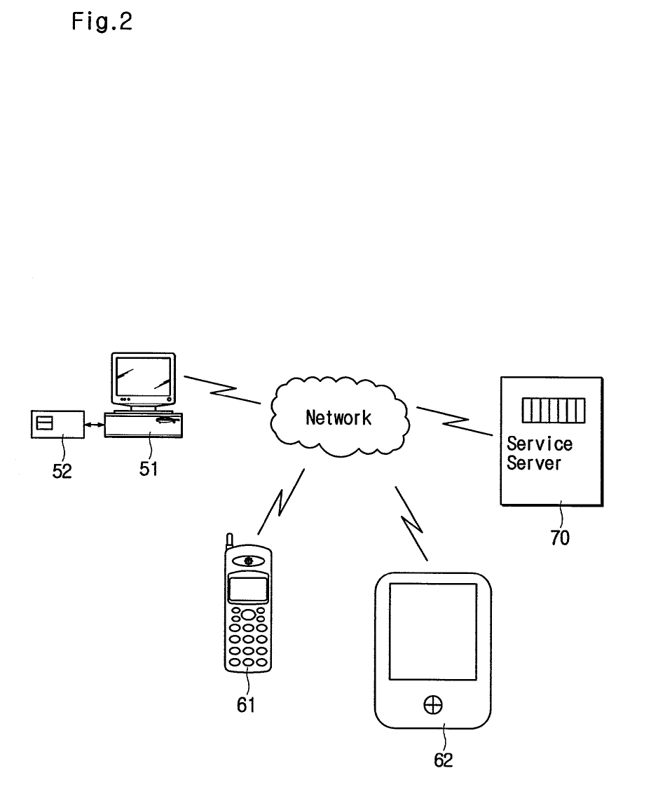

FIG. 2 briefly illustrates one embodiment of electronic payment system according to the present invention applied to electronic commerce on the Web. The user is interfaced by an electronic payment purpose input/output module 52 according to the present invention and connects to a service server 70 through the network via a personal computer 51 on which the electronic payment method according to the present invention is implemented. When the user is required to make a payment, as a result of accessing fee based contents or purchasing goods from an Internet shopping mall, can use the electronic payment method according to the present invention. The electronic payment purpose input/output module 52 comprises a user interface for finger print recognition and IC card reader. Prior to the filing date of the present invention, mobile communication terminal 61 or a finger print recognition module for mobile phone has already been developed and IC card interface is already in use. Hence, the use can use the electronic payment method according to the present invention even if accessing a wireless internet or some contents on the Web through a mobile communication terminal 61 or a mobile phone 62.

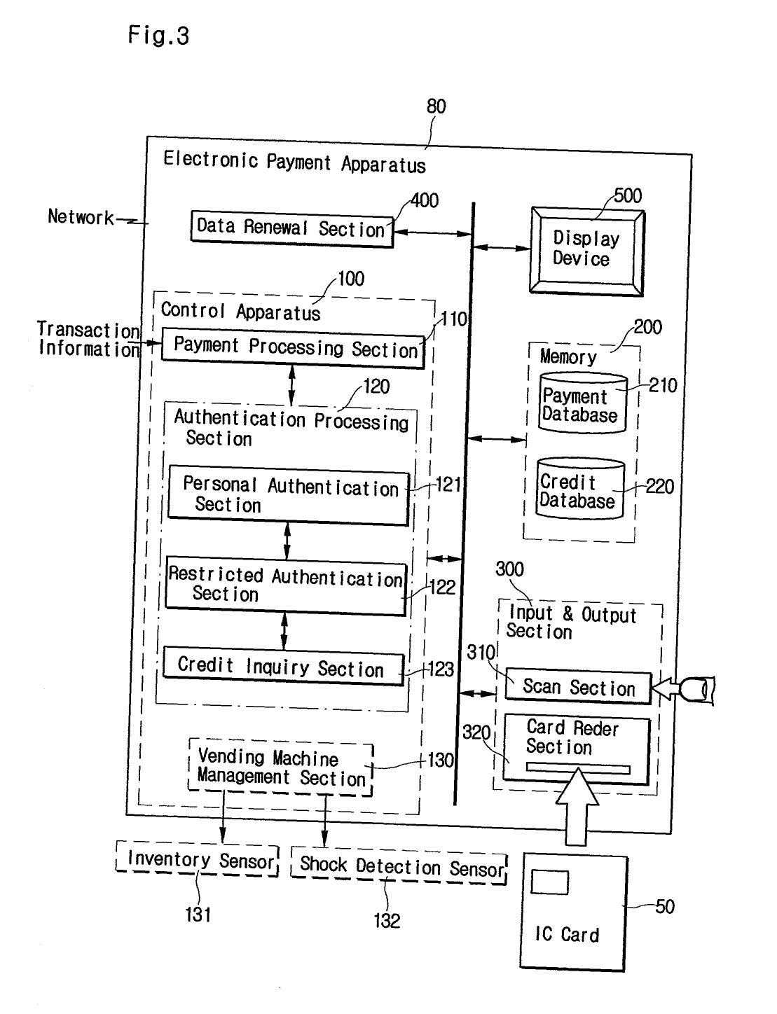

The electronic payment method according to a further embodiment of the present invention will be explained with reference to FIG. 3. As illustrated previously, the electronic payment method according to the present invention is based on microprocessor architecture. A control device 100 is preferably implemented through a microprocessor where RAM, ROM and peripheral devices are integrated. Memory 200 is a relatively large size auxiliary memory such as a hard disc or a flash memory. A data renewal section 400 can be either a MODEM or a network adapter. A display section 500 can either be a LCD display or an LED display which displays the information such as payment amounts or error history lists. An input/output section 300 comprises a scan section 310 which captures the images of finger prints or iris and further comprises a card reader section 320 which can communicate with an IC card 50. The IC card is preferably either a contact type or a non-contact type IC card since an encrypted form of important personal information being is communicated. Each of the devices is communicated through a common BUS.

Each of the blocks 110, 120 that forms the control device 100 is implemented through program codes. Each of the database 210, 220 of the memory 200 is implemented through in-built database tables in the memory. The details of the hardware that form the electronic payment apparatus 80 is omitted since it will be apparent to those skilled in the art from FIG. 3.

An authentication processing section 120 determines the suitability of the user who inserts an IC card. The authentication processing section 120 comprises a personal authentication section 121, a restricted authentication section 122 and a credit inquiry section 123.

The personal authentication section 121 checks whether the present card user is identical to the registered card user by checking whether the card data read from the scan section 310 matches with the one in the finger print database.

As a result, it can not only prevent illegitimate use of other user's card but also can effectively prevent minors purchasing adults goods by illegally using a registered adults goods purchase card.

The restricted authentication section 122 determines whether or not a user is eligible for a restricted transaction from the personal information obtained from the card reader section 320. For example, the goods to be purchased are tobacco or alcohol or adults sexual goods, it checks the user's age from the user's date of birth information stored in the IC card. Also, if the sales goods are only subjected to the inhabitants in a specific area, it can checks the user's address from the IC card. However, the possible embodiments of the present invention are not limited to the specific examples as shown above, it is possible to impose a various restrictions to restrict the subject of sales. If the use of electronic registration card is sufficiently wide spread and this card can also be used as a means of payment, it is also possible to impose a various restrictions to restrict the subject of sales based on the registered information on the electronic registration card.

The credit inquiry section 123 checks the credit database 220 where a black list (B/L) containing a list of prohibited users for transaction is stored. The credit database 220 is renewed periodically by the data renewal section 400 through the network. Although not illustrated in FIG. 1, a renewal by contacting a financial institution directly is also possible. Further, an offline renewal through periodical visits by a manager rather than through the network is also a possibility.

For the case, when the electronic payment apparatus 80 according to the present invention is implemented by a personal computer that uses the contents on the web, the authentication processing section 120 can add an authentication function based on a password word.

A payment processing section 110 receives the transaction information by interfacing through the outside and executes the payment by obtaining an authentication code from the authentication processing section 120. The payment processing section 110 authorizes the transaction if the balance information read from the card reader section 320 is greater than a transaction requested amount and control the card reader section 320 to store a new balance of which the transaction amount is subtracted in the IC card.

According to the authorization of the payment processing section 110, for example, the vending machine releases the selected goods to the goods exit. Afterwards, the payment processing section 110 stores the transaction information to the payment database 210. The information comprising the sales goods codes, sales amount, and date and time of sales are either periodically or non-periodically transmitted to a management server 30 via the data renewal section 400 by automatically or by the request of the management server 30. Hence, the management server can calculate for the total sales of each goods during a specific interval. In order to reduce the data communication load, it is preferable to restrict the renewal only to the records which are changed.

For the case, when the present invention is applied to a vending machine, the present invention can further comprises a vending machine management section 130. According to another embodiment of the present invention, the management of inventory is possible by renewing the inventory data of the payment database 210 according to the transaction information within the vending machine itself rather than managing by the management server 30 based on the calculated sales data. Accordingly, if the inventory of at least one of the goods on the menu list is below a certain level, an automatic inventory replenishment is ordered by contacting the management server through the renewal section through the control of the control device 100. If the inventory is replenished by the visit of the manager then the manager initializes the inventory amount by pressing an initializing button.

As a result, when the vending machine implemented by the present invention is utilized, the users will never be disappointed by sold out goods on the menu list. This way of doing inventory calculation in comparison to a sensor based inventory calculation can bring about a manufacturing cost reduction. However, the present invention is not disregarding the inventory calculation based on mechanical sensors or optical sensors. A various types of sensor constructions will be apparent to those skilled in the art therefore a detailed description thereof is omitted.

In the mean time, the vending machine management section 130 can further comprise a function which checks any damage in the vending machine and transmits the detail to the management server 30. The problem of vandalism against vending machines have always been a serious problem in the vending machine business.

Hence, the vending machine according of the present invention can further comprise a shock identification sensor 132, which upon a detection of a shock above a certain level applied against the vending machine, transmits a warning signal to the management server and sound out an alarm through an external speaker.

Next, the input/output section will be described in detail. The scan section 310 comprehensibly comprises a type of constructions that recognizes a person's specific feature of the body and converts it to a data form such as a finger print recognition module or an iris recognition module. The prior art concerning a various forms of the finger print recognition modules or iris recognition modules have been disclosed to the public prior to the filing date of the present invention.

The embodiment of the present invention that adopts a finger print recognition module will be described in detail hereafter. The finger print recognition processing is a special form of pattern recognition in the area of image processing and comprises the steps of extracting special features, classifying the finger print with respect to the special features, and matching through a comparison of classified and stored data with the special features data.

The special feature extracting step further comprises the steps of identifying the directional component of each flux line, binarizing through separations of the flux line and valleys and segmenting into 1 point lines by determining the thickness of each flux line. By processing this image once again through a noise reduction process, the special features are extracted in the form of directions and coordinates of the segmented lines.

When the characteristics of these special features are analyzed statistically, a good analyzing speed can be obtained in a 1 to many mapping. However, since the present invention utilizes a 1 to 1 mapping, the classified data is only optionally required. The extracted special features data as such are extracted as the finger print identification codes and these data are compared to the personal finger print identification codes already stored in the IC card. Accordingly, in comparison to the signal processing method, this method can improve the processing speed by reducing the calculation time. Further, in comparison to the method which transmits the extracted finger print identification codes to the server by contacting to the network therefore imposing a heavy load to the server forcing it to compare many finger print data in order for an authentication, the method by the present invention reduces the load imposed on the server and improves the processing speed. More importantly, it has an added advantage in the security side as no important personal data are distributed on the network.

The card reader section 320 can be a contact type or a non-contact type or a magnetic strip (MS) card and various shapes of cards according to their types were already disclosed to the pubic. In order to improve the reliability of communication between the card reader section 320 and an IC card 50, the error checking functions such as CRC check or Reed-Solomon Coding are added. Preferably, an encryption key should be stored in the IC card 50 as well as encoding the communication between the two devices.

Hence, the possibility of the balance in the IC card being improperly modified is prevented resulting an improvement in the IC card which acts as a type of electronic wallet in the electronic cash system. A various types of security systems for the electronic cash system have already proposed or implemented therefore a detailed description will not be given here.

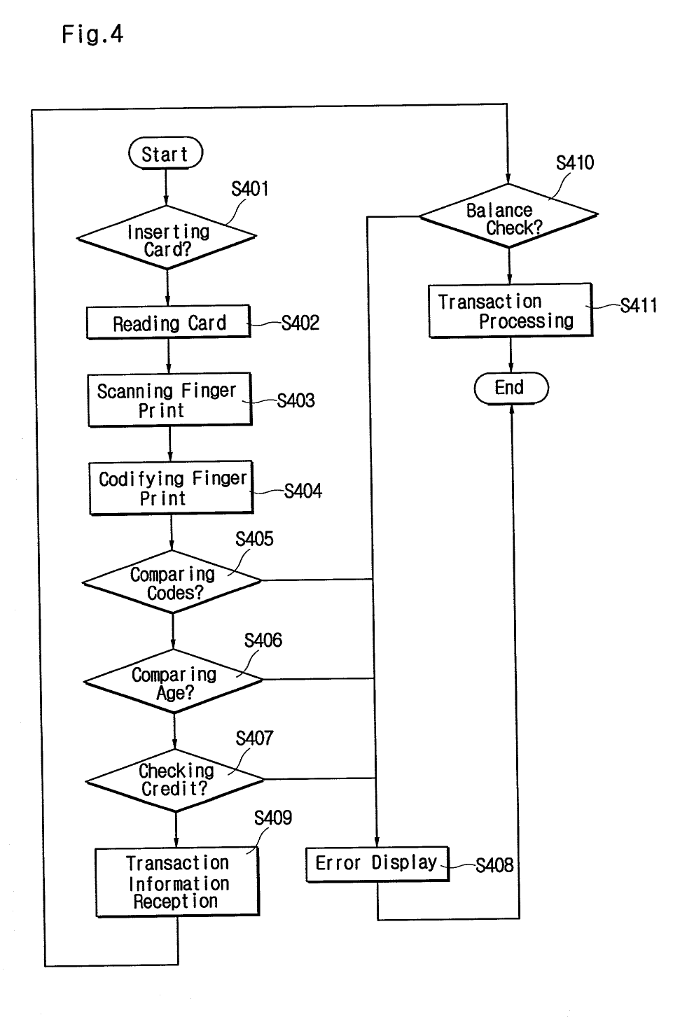

FIG. 4 shows a flow chart which illustrates an overall process flow of the electronic cash system according to the present invention.

A control device 100 initializes the transaction process and initiate the process (s401) once a card is inserted to the card reader section 320. Afterwards, the transaction process comprises the steps of reading the card data (s402) and outputting a message which requests a confirmation of finger print or iris and one particular part of a body is being scanned (s403). The next step involves codifying the scanned finger print according to the previously mentioned method or other disclosed methods (s404)

The next step involves determining whether the stored body identification codes read from the IC card matches with the calculated codes at the stage s404 (s405). The next step involves determining whether the user is eligible by comparing the personal information read from the IC card with the data such as the age data, i.e., checking whether the user is over 18 years old. The next step involves checking whether the user has a bad credit record by searching the black list which contains a list of bad creditors (s407). If the user is determined to be unsuitable for any of the authentication processing steps of s405, s406 and s407, it outputs an error code on the display and terminates the transaction process after storing the transaction log (s408). If the user is determined to be suitable for a transaction, it receives a transaction information which comprises transaction request amount, quantity and price from the vending machine module or the web application that provides the contents. If the balance stored in the IC card is greater than the requested transaction amount, the transaction is processed and is finally terminated. The transaction processing comprises the steps of, executing an initiation of sales through the interfaces of the vending machine's sale module (not shown on the diagram) or the contents application module (not shown on the diagram), receiving the information which informs a successful completion of the sales, controlling the card reader section 320 to renew the balance in the IC card with a new amount where the sales amount is deducted, storing the transaction log information which contains the data of sales and sales information in the payment database 210, and outputting a transaction completion message.

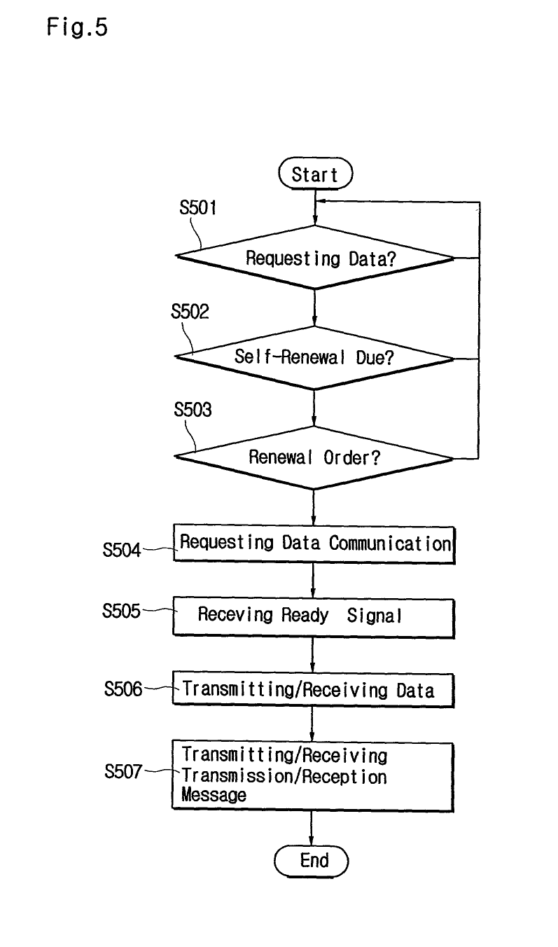

FIG. 5 shows a flow chart diagram which illustrates the communication process for a data renewal between the electronic payment process 80 and the management server 30. First of all, the step involves determining whether a data is being requested from the server (s501). The next step involves determining whether the time is due for a self-renewal (s502). The next step involves determining whether a renewal order from the manager has been inputted (s503). Hence, the data exchange with the server is initiated. First of all, the step involves requesting the server for data communication (s504). The next step involves receiving a signal that informs it is ready (s505). The next step involves transmitting/receiving the data with the server (s506). More specifically, the credit database 220 is renewed by receiving the up to date data mainly from the server and the payment log data stored in the payment database 210 are fully transmitted to the server.

At this instance, the communication load can be reduced by transmitting only the renewed log data. The final step involves terminating the communication by transmitting/receiving a transmission/reception message to the server (s507).

As described so far, the electronic payment apparatus according to the present invention provides a means for a secure and reliable personal authentication for the transaction of restricted sales goods such as adult goods or tobacco. Further, the present invention allows a high speed authentication and payment processing by providing a one to one processing of the body identification data in a off-line mode and a off-line processing of the black list. Additionally, it can protect the personal information by preventing the distribution of important personal information on the network. Also, the vending machine which implements the electronic payment apparatus according to the present invention has an added advantages of being able to provide functions such as remote sales calculation, remote inventory management, damage surveillance for remote vending machine. As a result, the customer reliability can be improved by preventing zero inventory and minimized the management manpower and maintenance and repair.

The present invention has been described with reference to the preferred embodiments. Obviously, modifications and alterations will occur to others upon reading and understanding the preceding detailed description. It is intended that the invention be construed as including all such modifications and alterations insofar as they come within the scope of the appended claims or the equivalents thereof.

What is claimed is:

1. An electronic payment apparatus, comprising:
a card reader section which reads personal information, the first body identification codes, and payment amount information from a card type storage medium;
a scan section which scans one particular part of a body and outputs the body identification data;
a personal authentication section which computes the second body identification codes from the body identification data of said scan section and processes the personal authentication by comparing between the first body identification codes from said card reader section and said second body identification codes;
a authentication processing section that includes a restricted authentication section which determines whether or not a user is eligible for a restricted transaction from the personal information obtained from said card reader section;
a payment processing section which receives the payment request from outside, executes payment process based on the payment amount information read from said card reader section and the authentication result from said authentication processing section, stores the result in a payment database, and controls said card reader section to renew the payment amount data in the card type storage medium; and
a display section which displays the payment result information.

2. The electronic payment apparatus as claimed in claim 1, wherein said authentication processing section further includes a credit inquiry section which determines whether or not a user is eligible for a transaction by inquiring through the credit database with the user identification information.

3. The electronic payment apparatus as claimed in claim 2, wherein said electronic payment apparatus further includes a data renewal section which periodic or non-periodically connects to a management server in order to renew a credit database and transmits the changes in the payment history of the payment database.

4. The electronic payment apparatus as claimed in any one of claims 1, 2 or 3, wherein said scan section is a finger print scanner and said body identification codes are finger print codes.

5. The electronic payment apparatus as claimed in any one of claims 1, 2 or 3, wherein said scan section is an iris identification camera and said body identification codes are iris codes.

6. The electronic payment apparatus as claimed in any one of claims 1, 2 or 3, wherein said restricted authentication section determines whether or not a user is eligible age for a restricted transaction from the age information of the personal information.

7. The electronic payment apparatus as claimed in any one of claims 1, 2 or 3, wherein said restricted authentication section 122 determines whether or not a user is residing in a valid area for a restricted transaction from the address information of the personal information.

8. An electronic payment method, comprising the steps of:
reading personal information, the first body identification codes, and balance information from a card type storage medium;
scanning one particular part of a user's body;
calculating the second body identification codes by processing the scanned data;
personally authenticating by comparing between the first body identification codes and the second body identification codes and determining whether or not the user is eligible for a restricted transaction from said personal information;
executing the payment process based on said balance information by receiving the payment request information from outside when successful in authenticating, and storing the result in a payment database, and renewing the payment amount in a card type storage medium; and
displaying the transaction result.

9. The electronic payment method as claimed in claim 8, wherein said authenticating step further includes a credit inquiry step which determines whether or not a user is eligible for a transaction by inquiring through the credit database with the user identification information.

10. The electronic payment method as claimed in claim 9, further including a data renewal step which periodic or non-periodically connects to a management server in order to renew a credit database and transmits the changes in the payment history of the payment database.

11. The electronic payment method as claimed in any one of claims 8, 9 or 10, wherein said scanning step involves scanning of the user's finger print.

12. The electronic payment method as claimed in any one of claims 8, 9 or 10, wherein said scanning step involves image capturing of the user's iris.

13. The electronic payment method as claimed in any one of claims 8, 9 or 10, wherein said determining step of whether or not the user is eligible for the restricted transaction involves determining whether the age is suitable for the restricted transaction from the age information of the personal information.

14. The electronic payment method as claimed in any one of claims 8, 9 or 10, wherein said determining step of whether or not the user is eligible for the restricted transaction involves determining whether the resident area is valid for the restricted transaction from the address information of the personal information.

15. A vending machine, implementing the electronic payment apparatus as claimed in claim 1.

16. The vending machine as claimed in claim 15, wherein said authentication processing section further includes a credit inquiry section which determines whether or not a user is eligible for a transaction by inquiring through the credit database with the user identification information.

17. The vending machine as claimed in claim 16, wherein said electronic payment apparatus further includes a data renewal section which periodic or non-periodically connects to a management server in order to renew a credit database and transmits the changes in the payment history of the payment database.

18. The vending machine as claimed in any one of claims 15, 16 or 17, wherein said scan section is a finger print scanner and said body identification codes are finger print codes.

19. The vending machine as claimed in any one of claims 15, 16 or 17, wherein said scan section is an iris identification camera and said body identification codes are iris codes.

20. The vending machine as claimed in any one of claims 15, 16 or 17, wherein said restricted authentication section determines whether the age is suitable for the restricted transaction from the age information of the personal information.

21. The vending machine as claimed in any one of claims 15, 16 or 17, wherein said restricted authentication section determines whether the resident area is valid for the restricted transaction from the address information of the personal information.

22. The vending machine as claimed in any one of claims 15, 16 or 17, wherein said electronic payment apparatus further includes a vending machine management section which calculates the present inventory of the vending machine and request an inventory replenishment to the management server.

23. The vending machine as claimed in any one of claims 15, 16 or 17, wherein said electronic payment apparatus further includes a vending machine management section which upon a detection of a shock above a certain level applied against the vending machine, transmits a warning signal to the management server and sound out an alarm through an external speaker.
